(19) United States
(12) Patent Application Publication
(10) Pub. No.: US 2021/0297404 A1
(43) Pub. Date: Sep. 23, 2021

(54) METHODS AND SYSTEMS OF ENABLING USER AUTHENTICATION VALIDATION

(71) Applicant: AVAYA MANAGEMENT L.P., Santa Clara, CA (US)

(72) Inventors: Mahendra Rochwani, Pune (IN); Arjun Sharma, Pune (IN); Chirag Patel, Pune (IN); Firozshah Attar, Pune (IN)

(21) Appl. No.: 16/825,648

(22) Filed: Mar. 20, 2020

(51) Int. Cl. H04L 29/06

(52) U.S. Cl. CPC H04L 63/083; H04L 63/20

(57) ABSTRACT

In embodiments of the present invention, features of an improved user authentication system features include receiving, by a processor of a computer system receiving a request for authorizing a first user, transmitting a prompt to a second user, receiving a first code from the second user, and transmitting the first code to a network location, and enabling access for the second user to the network location. Methods and systems include transmitting the first code to a network location accessible by authorized users.

### FIELD

The present disclosure relates generally to communication systems and more particularly to methods and systems for authenticating users.

### BACKGROUND

Modern communications are increasingly conducted via remote means. Whether by voice calling, text messages, email, or other means, companies are constantly in contact with people using remote communications. Scam artists, phishing attackers, and others take advantage of the commonality of these remote communications by posing as reputable representatives of organizations such as banks, the government, and other entities.

Users of user devices such as cellphones often receive calls where a fraudulent caller claims to be calling from a bank, a service provider of which the user may be a customer or subscriber, or other entity. The intention of such a fraudulent caller may be to seek private and/or confidential information from the user which leads to fraudulent activity, for example, money deducted from user's account or the bank account getting hacked, fraudulent credit card usage, misuse of sensitive information etc.

Because of the high danger of fraudulent callers and the ease at which such fraudulent callers operate, the problem of fraudulent callers is extremely important to solve. Similar issues arise with fraudulent emailers, fraudulent texters, and other fraudulent scammers posing as reputable representatives of business entities. Because of the risk in communicating over the phone or via text, many people choose not to use the otherwise simple means of communication or suffer from the distress of knowing the risk and not having any suitable alternative and less risky means of communicating.

These problems with remotely communicating via voice and/or text have arisen along with the rise of the Internet in modern life. Prior to computers being used to gain personal information such as contact information, banking information, etc., fraudulent callers were less of a problem as the callers were less likely to know enough information about a recipient to successfully pose as a reputable representative of a business entity with which the recipient has a business relationship.

Thus, there are still yet-unsolved problems associated with the ability of different groups of users, companies, or other entities to share sensitive data over a network environment. The present disclosure provides technical methods and systems which overcome the problems associated with conventional systems, as described below.

### BRIEF DESCRIPTION OF THE DRAWINGS

The following detailed description of certain embodiments of the present disclosure may be understood by reference to the following figures:

FIG. 1 shows a computer network environment in accordance with one or more of the embodiments described herein;

FIG. 2 shows a computer system in accordance with one or more of the embodiments described herein;

FIGS. 3A-3D are illustrations of embodiments of graphical user interfaces (GUIs) in accordance with one or more of the embodiments described herein;

FIG. 4A is an illustration of an embodiment of a GUI in accordance with one or more of the embodiments described herein;

FIG. 4B is an illustration of a flow of information during a process of confirming whether a caller is authorized in accordance with one or more of the embodiments described herein;

FIG. 5 is a flow chart of a method in accordance with one or more of the embodiments described herein; and

FIG. 6 is a flow chart of a method in accordance with one or more of the embodiments described herein.

While the invention has been described in connection with certain preferred embodiments, other embodiments would be understood by one of ordinary skill in the art and are encompassed herein.

### DETAILED DESCRIPTION

The present disclosure describes a system for authenticating users such as callers calling on behalf of a business entity or users of computer devices communicating with others via text on behalf of a business entity. The problems with contemporary means of communications as discussed above may be solved through technical means as described herein.

The following detailed description refers to the accompanying drawings that show, by way of illustration, details and embodiments in which the invention may be practiced. These embodiments are described in sufficient detail to enable those skilled in the art to practice embodiments of the present invention. Other embodiments may be utilized and structural, logical, and electrical changes may be made without departing from the inventive subject matter. The various embodiments disclosed herein are not necessarily mutually exclusive, as some embodiments can be combined with one or more other embodiments to form new embodiments. The following detailed description is, therefore, not to be taken in a limiting sense.

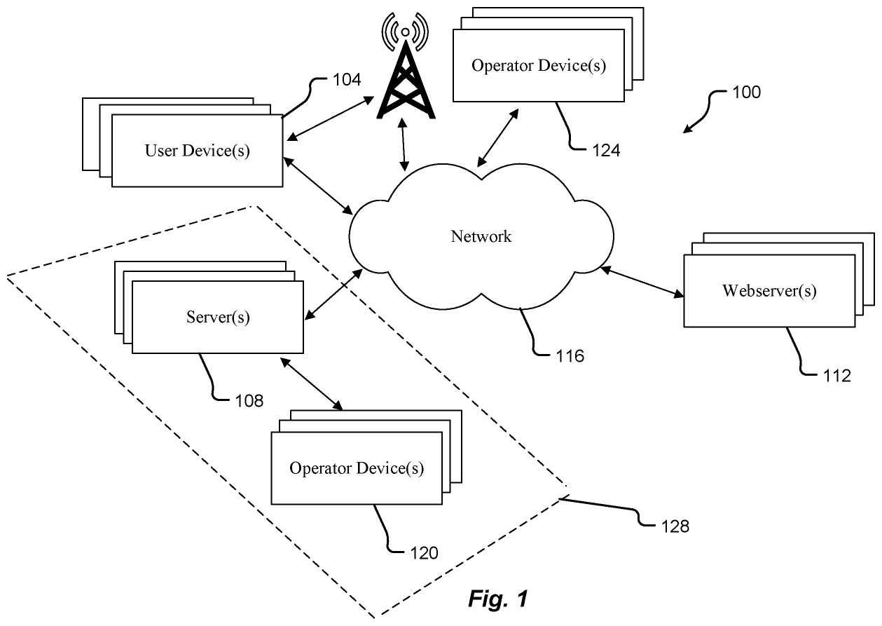

In some embodiments, a computer-implemented method for verifying reputability of users may execute in an environment 100 including one or more user devices 104, one or more servers 108, one or more webservers 112, and one or more operator devices 120, 124 connected via a network 116 as illustrated in FIG. 1. One or more of the operator devices 120 may be connected to one or more servers 108 via a local connection forming a local network 128 and may connect to the network 116 via a connection with a local server 108 or through other means. By interconnecting one or more user devices 104, one or more servers 108, and/or one or more webservers 112 via a network 116, a communication session may be implemented allowing users of user devices 104 to communicate with users of operator devices 102, 124 via a variety of means such as telephone, web-conferencing, text messaging (e.g. SMS), email, etc.

User devices 104 may in some embodiments comprise personal computers, laptops, tablet devices, smartphones, or any other type of device capable of executing an application such as an Internet browser. In some embodiments, a communication session may be executed within a browser window such as Internet Explorer™, Google™ Chrom™, Firefox™, etc. and may be implemented using a Javascript™ application.

The environment 100 may comprise one or more servers 108. Servers 108 may be dedicated servers configured to host one or more communication sessions for a multitude of users. It should be noted that a server 108 should not be considered as required in certain embodiments. For example, either of a webserver 112 and/or a user device 104 may be capable of hosting a communication session.

Webserver(s) 112 may comprise network connected computer systems hosting one or more webpages. Information hosted on web servers 112 may be accessed during communication sessions and may be displayed in GUI elements on one or more user devices via browser windows.

A server 108 and/or a webserver 112 can be or may include any server that is capable of executing a communication session between two or more user devices 104 to view web pages provided by a web server 112.

The web server 130 can be or may include any software/hardware that can work with the browser 104 to provide one or more web pages 131, such as Apache®, Nginx®, Microsoft-ITS®, Tomcat®, and/or the like. The web server 130 may comprise a plurality of web servers 130. For example, the web server 130 may comprise different web servers 130 from different companies, enterprises, groups, and/or the like. The web server 130 provides web page(s) 131 that can be viewed by a user running a browser 104 on a communication endpoint.

A network 116 may be a private network, a local-area network, or a wide-area network such as the Internet. For example, a private network accessible within a corporation may host a communication system, while in some embodiments communication may take place across the Internet or using phone lines, cell towers, etc.

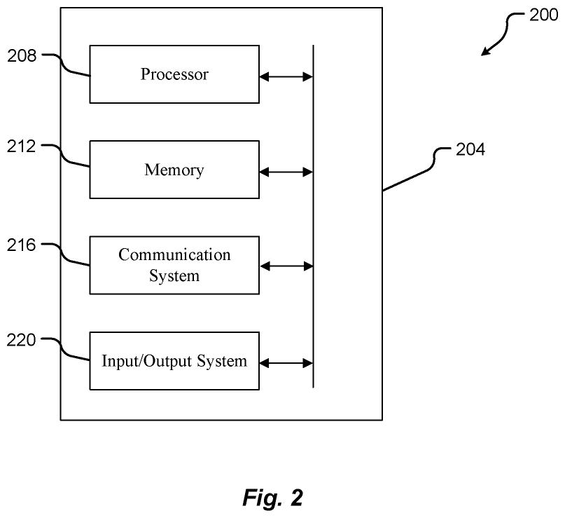

Any of the user devices 104, servers 108, 112, and/or other computer systems as described herein may be as illustrated in FIG. 2. A computer system 204 may comprise a processor 208, a memory element 212, a communication system 216, and an input/output system 220.

A processor 208 can be or may include any hardware processor, such as a Digital Signaling Processor (DSP), an application specific processor, a microcontroller, a multi-core processor, and/or the like. Examples of the processors as described herein may include, but are not limited to, at least one of Qualcomm® Snapdragon® 800 and 801, Qualcomm® Snapdragon® 610 and 615 with 4G LTE Integration and 64-bit computing, Apple® A7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i7-4770K 22 nm Haswell, Intel® Core® i5-3570K 22 nm Ivy Bridge, the AMD® FX™ family of processors, AMD® FX-4300, FX-6300, and FX-8350 32 nm Vishera, AMD® Kaveri processors, Texas Instruments® Jacinto C6000™ automotive infotainment processors, Texas Instruments® OMAP™ automotive-grade mobile processors, ARM® Cortex™-M processors, ARM® Cortex-A and ARIV1926EJ-S™ processors, other industry-equivalent processors, and may perform computational functions using any known or future-developed standard, instruction set, libraries, and/or architecture.

A memory element 212 may be any computer readable storage medium, such as a memory (i.e., a computer memory, a hard disk, and/or the like). A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A communication system 216 can be or may include any hardware interface coupled with software that can communicate with the network 116. For example, the communication system 216 can be a wireless interface, a wired interface, a fiber optic interface, an Ethernet interface, a cellular interface, a WiFi interface, and/or the like.

An input/output system 220 can be or may include any type of hardware interface coupled with software that can communicate with a user of the computer system 200. For example, keyboard, mouse, display screen, microphone, speaker, etc.

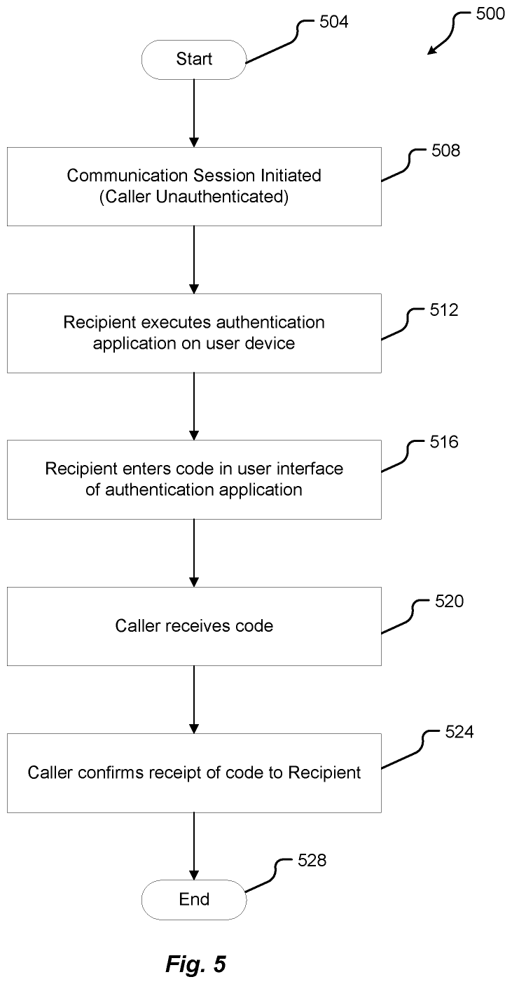

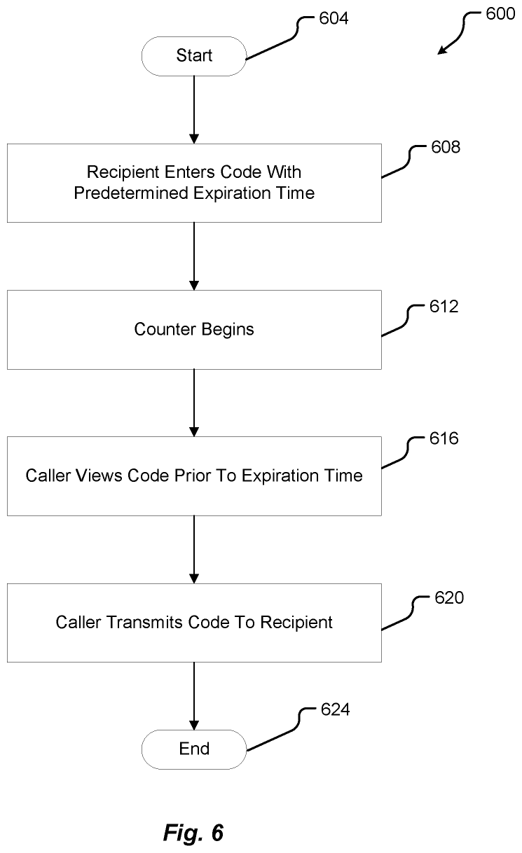

In some embodiments, the systems and methods described herein may be executed on one or a combination of a server, a webserver, or a user device. FIGS. 5 and 6 are flow diagrams of processes of verifying the authenticity of a caller. Browsers executing on user devices may display GUI elements and may be in communication with one or more other user devices, one or more servers, and/or one or more webservers via a network location. The methods described herein and illustrated by the flow diagrams of FIGS. 5 and 6 may be executed by processors or microprocessors of computer devices which may perform the methods. The processes described herein may be performed by executing program instructions stored in a computer readable storage medium such as a memory device. Although the methods described in relation with FIGS. 5 and 6 are shown in a specific order, one of skill in the art would recognize that the steps in FIGS. 5 and 6 may be implemented in different orders and/or be implemented in a multi-threaded environment. Moreover, various steps may be omitted, added, or repeated based on implementation.

In certain embodiments of the present disclosure, a system of authenticating a caller or a user using a means of communication such as audio, text, video, etc., may be implemented. For example, in some embodiments, a one-sided method of user authentication may be implemented. For example, a caller calling a recipient in which the caller purports to be calling on behalf of an entity known to the recipient may be verified by the recipient using a one-side method of user authentication. In other embodiments, both the caller and recipient may each be independently verified by the other using a two-sided user authentication method. A one-sided user authentication method may be as described below and in relation to each of the figures.

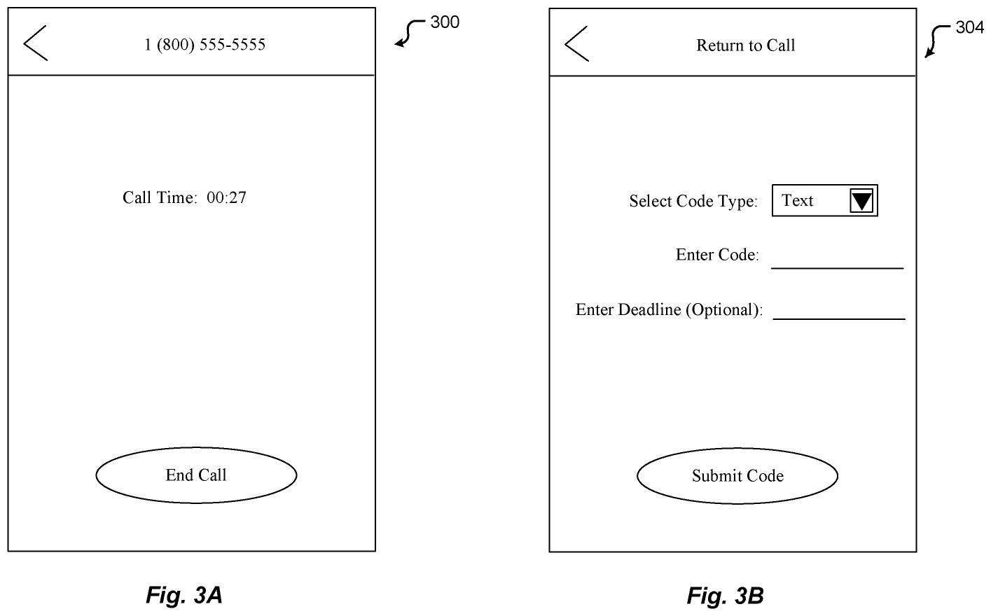

For example, a one-side user authentication method 500 as illustrated by the flowchart of FIG. 5 may start at step 504 in which a computing environment as illustrated in FIG. 1 may be used to connect a caller to a recipient. Note that the caller and recipient terms should not be implied as limiting the disclosure as relating to phone calls, but should be considered as including the possibility of the caller contacting the recipient via text, SMS, email, video chat, etc. In some embodiments, a phone call may be made by the caller to the recipient. As illustrated in FIG. 3A, a user interface 300 displayed on a user device associated with the recipient may show a caller's phone number, a time duration, a graphical user interface (“GUI”) button to enable the recipient to end the call, or other GUI elements.

In step 508, a communication session may be initiated between two or more users. In some embodiments, a beginning of a communication session between a caller and a recipient may be detected by a computer system. For example, in some embodiments, a server 108 or webserver 112 may be capable of detecting a caller calling a recipient. A caller may be an agent for a company and may be calling from within a local network 128 of the company. For example, a telephonic call agency may have a plurality of phones. Each phone may be capable of communicating with a server. The server may be capable of detecting incoming and outgoing phone calls. In this way, the server may detect the beginning of a communication session involving one of the phones. Note that the communication session may involve computers instead of phones and may be a textual communication, a voice communication, a video communication, or any other kind of communication session.

In some embodiments, the beginning of the communication session may simply be detected by the user device of the recipient being used to communicate with the caller. In some embodiments, the beginning of the communication session may be detected be based on user input, for example a user may select a graphical user interface button initiating the process.

After the communication session begins, a user participating in the communication session may initiate an authentication process in step 512. For example, a user may execute an authentication application on a user device. In some embodiments, the authentication application may be executed on the same or a different user device as a device used to conduct the communication session.

An authentication application executed on a user device may be as illustrated by the user interface 304 of FIG. 3B. Upon executing the authentication application, a recipient's user device may display a user interface 304 and may be prompted to enter a code in step 516. In some embodiments, a recipient may be capable of selecting between a number of types of codes. For example, a text string, an image, an audio file, etc., may be used as a code. Using the authentication application, the user may enter a custom code, for example a random four digit number, a word, a two second recording of the user saying a word or number, or any other way to say, type, draw, etc., a code.

In some embodiments, a user may be asked to log in to the authentication application. For example, the user may type in a user ID and/or password which may be used to verify the identify of the user. In some embodiments, a user may be asked to enter or select from a list of entities with which the caller is purporting to be associated. In some embodiments, a particular entity, such as a corporation, may use its own authentication application. For example, a user receiving a call from a caller purporting to be associated with Company A may execute a Company A authentication application on his or her user device.

In some embodiments, a code may be associated with a deadline, time limit, or other type of expiration factor. The user may, in addition to entering a code, enter a time limit, such as 24 hours, 30 seconds, or a deadline or expiration date such as Jan. 5, 2027.

The user interface 304 may include a GUI button to enable the user to submit the entered code. Upon a user entering and submitting a code via an authentication application, the code may be transmitted to a network location. Along with the code, other information may be transmitted, for example, a deadline or time limit for the code, user identification information, entity identity information, etc. The code and other information may be sent from the user device 104 of the recipient to a server 105 or other network location via a network 115 as illustrated in FIG. 1. In some embodiments, a database may be managed storing codes from a number of users. In some embodiments, one entity, such as Company A, may manage its own database of codes.

As servers or other network locations receive codes from users, a computer system may analyze the received codes to determine an identity of the user who submitted the code. In some embodiments, the computer system may further determine the entity with which the caller purports to be associated.

Users authorized by a particular entity may be registered and may be capable of accessing the database of codes. In some embodiments, an application executable on user devices may be accessible by authorized users of certain embodiments. Such application may be used by authorized users to view codes entered by users who have received calls.

For example, a user authorized to make calls in representation of a business or other type of entity may access an application executing on a computer system or other type of user device. The application may be configured to access a secure database storing codes entered by users who have received calls.

As illustrated in FIG. 3C, a user interface 308 may be displayed on a user device of an authorized user. The user interface 308 may display a code received from a user, an identity of the user, and/or an indication of a time at which the code may expire. In some embodiments, the code may be automatically sent to the authorized user. For example, a computer system in communication with a database storing codes may be capable of determining an identity of a user having uploaded the code and an identity of a user who called the code (prompting the code entry). The computer system may then transmit the code along with identity information relating to the user having uploaded the code. In some embodiments, the authorized user may be capable of using the application to look up the code for example by searching for a name of the user who entered the code.

In step 520, the caller may receive the code for example by using an application and viewing a display of a user interface 208 as illustrated in FIG. 3C. The caller may then confirm receipt of the code to the recipient in step 524 for example by simply saying the code aloud to the recipient or by typing the code and sending the code to the recipient in the case of a text conversation.

In some embodiments, a recipient may be capable of informing the server or computer system managing the authorization system as to whether the caller received the code. For example, as illustrated in FIG. 3D, a user interface 312 may display on a user device of a recipient executing an authorization confirmation application. Using the user interface 312, the recipient may be capable of reporting whether the code was received, the contents of the code received and/or an identity of from whom the code was received. After the code has been received by the recipient, the method 500 may end at step 528.

In some embodiments, multiple users participating in a single communication session may be verification. For example, each user may be capable of accessing a secure database to enter his or her identity as well as a custom code. The users participating in the communication, if authorized, may be sent each custom code entered by other users. For example, consider a scenario in which two employees of a company are speaking on the phone or communicating via text message. If one or both of the employees are unsure as to whether the other is truly an employee, each employee may execute an authorization verification application on his or her user device. When a first user on the call hears the second user on the call read out or otherwise describe the first user's code, the first user can be assured the second user has access to the secure system where the codes are stored.

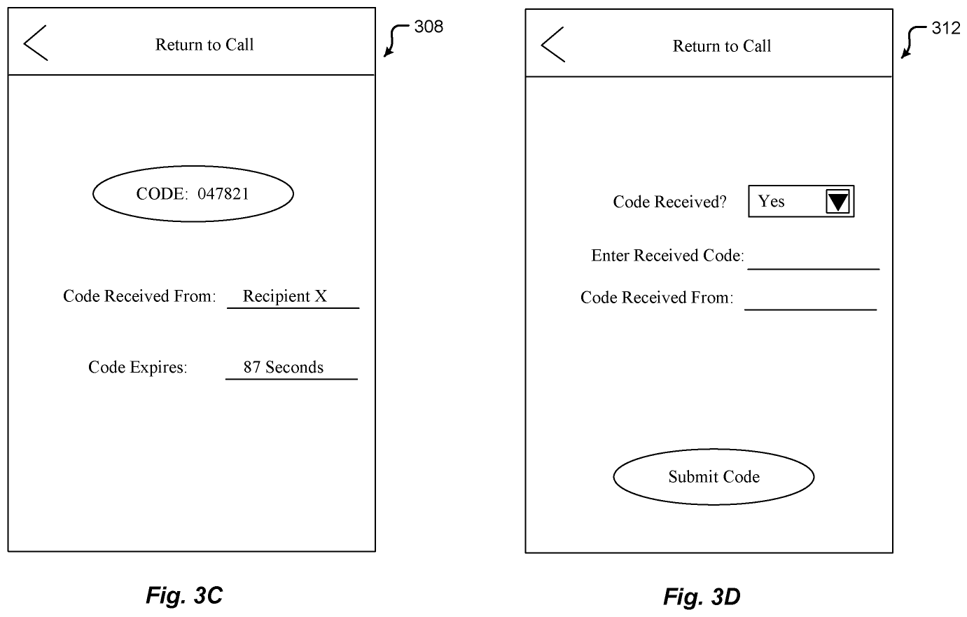

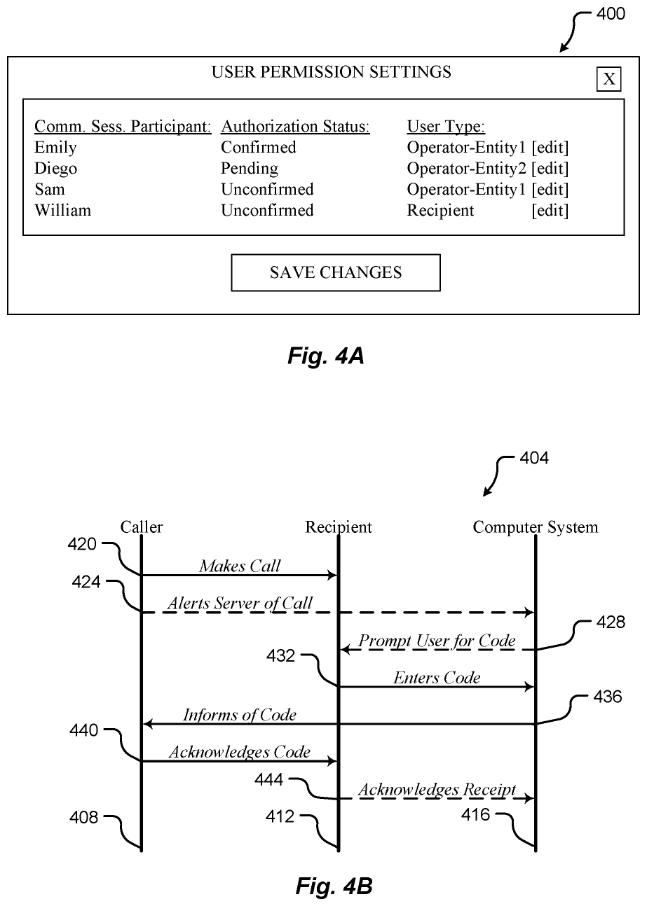

As illustrated in FIG. 4A, a user interface 400 may be displayed on any computer system of user device in communication with a computer system or server executing or hosting an authorization verification system. Such a user interface 400 may be used to manage communication session participants, status of authorization of the participants, and/or user types. For example, participants of a communication session may be confirmed after successfully retrieving and acknowledging a code of another user, participants may be pending following a code of another user being entered and prior to retrieving and acknowledging the code, or unconfirmed prior to another user entering a code. Each user participating in the communication session may be assigned a user type. For example, callers purporting to be calling on behalf of a particular organization may be assigned a type indicating their purported affiliation. In the event of a communication session involving a number of participants, each may be identified separately. For example, a participant named Emily may purport to be an operator calling on behalf of Entity 1 and may be assigned user type “Operator-Entity1.” The recipient of the call, may similarly be assigned a user type of “Recipient.”

As illustrated in FIG. 4B, the process 404 of a caller calling a recipient while purporting to be an authorized representative of a particular entity and being verified using a method as described herein may involve a series of data transactions between nodes. Node 408 represents a caller. For example, node 408 may be a user device executing a communication system such as a telephone or computer. As described herein, a communication session may be via voice, text, video, etc. Node 412 represented a recipient of the call, for example a user device executing a similar communication system. Node 416 represents a computer system such as a server or other system capable of executing an authorization verification system.

The process 404 may begin with the caller making a call 420 to the recipient. As discussed above, the “call” may also be a text message, an email, a group chat, a video call, etc. As the call 420 is made, the caller device may also alert 424 the server or computer system of the call being made. For example, the call 420 may be made by an agent of a business entity. The call 420 may be made from a user device in communication with a computer system of the business entity via a network. Upon the call 420 being made, the computer system of the business entity may be capable of automatically detecting the call 420, detecting the identity of the caller 408, and detecting the identity of the recipient 412. The computer system 416 being alerted 424 of the call 420 may be an optional step and the process may be similarly performed without such a step.

If and when the computer system 416 is alerted 424 of the call 420, the computer system 416 may optionally prompt 428 the recipient for a code. For example, the recipient may receive a message such as an SMS or email from the computer system 416 asking the recipient to download and/or execute an authorization verification application on a user device associated with the recipient.

The recipient device 412 may be used to enter a code to use in the authorization verification process. For example, the recipient device 412 may execute an application in which a code may be entered. The recipient may use the device 412 to create a custom code which may be sent in a secure message 432 to the computer system 416 which may be accessible only to authorized users.

The computer system 416 may in some embodiments inform the caller (if the caller is an authorized user) of the code in a secure message 436. In some embodiments, the caller may be notified by a message 436 which may prompt the caller to execute an application on the caller's device with which the caller may be capable of viewing the recipient's code.

Upon the authorized caller learning the recipient's code, the authorized caller may acknowledge receipt 440 of the code, for example by telling the recipient the contents of the code. Likewise, the recipient may use the application executing on his or her user device to acknowledge 444 to the computer system 416 as to whether or not the code was received by the caller. If the caller does not acknowledge the code to the recipient, the recipient may be alerted to the possibility that the caller is fraudulent as the caller does not have access to the secure database.

As referenced above, in some embodiments a code may be associated with an expiration date or time. For example, a code may be set to expire within a given amount of time after the code is entered. As illustrated in FIG. 3B, the expiration date or time may be set by the user upon entering the code. In some embodiments, the expiration date or time may be set by an entity hosting the authorization verification system. As illustrated by the flowchart of FIG. 6, a method 600 may be implemented to handle the scenario of an expiring code. The method 600 may begin at step 604 in which a communication session between a caller, who may be authorized or unauthorized, and a recipient is taking place. In step 608, the recipient may enter a code into an authorization verification application and the recipient may select an expiration time limit. In some embodiments, all codes may automatically be associated with a particular, predetermined, time limit.

After the code is entered in step 608, a counter may begin in step 612. The counter may run from the time the code is submitted by the recipient until the end of the expiration time limit. In some embodiments, a particular time of day or date may be used as opposed to a time limit. In such embodiments, the counter may simply run until the chosen time of day or date.

At step 616, the caller participating in the communication session may execute another application on his or her user device and view the code as entered by the recipient. In this way, only authorized callers who have access to the secure database holding the codes may be capable of viewing the codes. If the caller takes too long to view the code, and does not view the code prior to the expiration of the time limit, the code may be removed from the database. In step 620, the caller may inform the recipient as to whether or not the caller viewed the code and if the caller viewed the code the caller may inform the recipient as to the contents of the code entered by the recipient. In this way, the recipient can be assured that the caller is authorized, as the caller can confirm the caller has access to the secure database, and that any code entered by the recipient will not remain on the database beyond the set time limit. The method 600 may end at step 624 in which the communication session may be continued with the caller having been verified as being an authorized representative of his or her entity.

Any of the steps, functions, and operations discussed herein can be performed continuously and automatically.

The exemplary systems and methods of this disclosure have been described in relation to communication applications. However, to avoid unnecessarily obscuring the present disclosure, the preceding description omits a number of known structures and devices. This omission is not to be construed as a limitation of the scope of the claimed disclosure. Specific details are set forth to provide an understanding of the present disclosure. It should, however, be appreciated that the present disclosure may be practiced in a variety of ways beyond the specific detail set forth herein.

Furthermore, while the exemplary embodiments illustrated herein show the various components of the system collocated, certain components of the system can be located remotely, at distant portions of a distributed network, such as a LAN and/or the Internet, or within a dedicated system. Thus, it should be appreciated, that the components of the system can be combined into one or more devices, such as a server, communication device, or collocated on a particular node of a distributed network, such as an analog and/or digital telecommunications network, a packet-switched network, or a circuit-switched network. It will be appreciated from the preceding description, and for reasons of computational efficiency, that the components of the system can be arranged at any location within a distributed network of components without affecting the operation of the system.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire, and fiber optics, and may take the form of acoustic or light waves, such as those generated during radio-wave and infra-red data communications.

While the flowcharts have been discussed and illustrated in relation to a particular sequence of events, it should be appreciated that changes, additions, and omissions to this sequence can occur without materially affecting the operation of the disclosed embodiments, configuration, and aspects.

A number of variations and modifications of the disclosure can be used. It would be possible to provide for some features of the disclosure without providing others.

In yet another embodiment, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this disclosure. Exemplary hardware that can be used for the present disclosure includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as a program embedded on a personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Although the present disclosure describes components and functions implemented in the embodiments with reference to particular standards and protocols, the disclosure is not limited to such standards and protocols. Other similar standards and protocols not mentioned herein are in existence and are considered to be included in the present disclosure. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present disclosure.

The present disclosure, in various embodiments, configurations, and aspects, includes components, methods, processes, systems and/or apparatus substantially as depicted and described herein, including various embodiments, subcombinations, and subsets thereof. Those of skill in the art will understand how to make and use the systems and methods disclosed herein after understanding the present disclosure. The present disclosure, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease, and/or reducing cost of implementation.

The foregoing discussion of the disclosure has been presented for purposes of illustration and description. The foregoing is not intended to limit the disclosure to the form or forms disclosed herein. In the foregoing Detailed Description for example, various features of the disclosure are grouped together in one or more embodiments, configurations, or aspects for the purpose of streamlining the disclosure. The features of the embodiments, configurations, or aspects of the disclosure may be combined in alternate embodiments, configurations, or aspects other than those discussed above. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the disclosure.

Moreover, though the description of the disclosure has included description of one or more embodiments, configurations, or aspects and certain variations and modifications, other variations, combinations, and modifications are within the scope of the disclosure, e.g., as may be within the skill and knowledge of those in the art, after understanding the present disclosure. It is intended to obtain rights, which include alternative embodiments, configurations, or aspects to the extent permitted, including alternate, interchangeable and/or equivalent structures, functions, ranges, or steps to those claimed, whether or not such alternate, interchangeable and/or equivalent structures, functions, ranges, or steps are disclosed herein, and without intending to publicly dedicate any patentable subject matter.

Embodiments include a computer-implemented method of authorizing a first user, the method comprising performing operations as follows on a processor of a computer system: receiving a request for authorizing the first user; transmitting a prompt to a second user; receiving a first code from the second user; transmitting the first code to a network location, wherein the network location is accessible by authorized users; and enabling access for the second user to the network location.

Aspects of the above method include the method further comprising receiving confirmation from the second user that the first user received the first code.

Aspects of the above method include the method further comprising, upon receiving confirmation from the second user, activating a communication session between the first user and the second user.

Aspects of the above method include the method further comprising: transmitting a prompt to the first user; receiving a second code from first user; transmitting the second code to a user device associated with the second user.

Aspects of the above method include wherein the first code is one of a text string, an image, and an audio clip.

Aspects of the above method include wherein upon receiving the request for authorizing the first user, a timer is started, wherein if the timer reaches a predetermined amount of time prior to the first code being received, a new prompt is transmitted to the second user.

Aspects of the above method include wherein transmitting the prompt comprising displaying a graphical user interface button in a user interface of an application executing on a user device associated with the second user.

Embodiments include a system, comprising: a processor; and a computer-readable storage medium storing computer-readable instructions which, when executed by the processor, cause the processor to: receiving a request for authorizing the first user; transmitting a prompt to a second user; receiving a first code from the second user; transmitting the first code to a network location, wherein the network location is accessible by authorized users; and enabling access for the second user to the network location.

Aspects of the above system include wherein the computer-readable instructions, when executed by the processor, further cause the processor to receiving confirmation from the second user that the first user received the first code.

Aspects of the above system include wherein the computer-readable instructions, when executed by the processor, further cause the processor to, upon receiving confirmation from the second user, activating a communication session between the first user and the second user.

Aspects of the above system include wherein the computer-readable instructions, when executed by the processor, further cause the processor to: transmitting a prompt to the first user; receiving a second code from first user; transmitting the second code to a user device associated with the second user.

Aspects of the above system include wherein the first code is one of a text string, an image, and an audio clip.

Aspects of the above system include wherein upon receiving the request for authorizing the first user, a timer is started, wherein if the timer reaches a predetermined amount of time prior to the first code being received, a new prompt is transmitted to the second user.

Aspects of the above system include wherein transmitting the prompt comprising displaying a graphical user interface button in a user interface of an application executing on a user device associated with the second user.

Embodiments include a computer program product, comprising: a non-transitory computer-readable storage medium having computer-readable program code embodied therewith, the computer-readable program code configured when executed by a processor to: receive a request for authorizing the first user; transmit a prompt to a second user; receive a first code from the second user; transmit the first code to a network location, wherein the network location is accessible by authorized users; and enable access for the second user to the network location.

Aspects of the above computer program product include wherein the computer-readable program code is further configured to, when executed by the processor, receive confirmation from the second user that the first user received the first code.

Aspects of the above computer program product include wherein the computer-readable program code is further configured to, when executed by the processor, upon receiving confirmation from the second user, activating a communication session between the first user and the second user.

Aspects of the above computer program product include wherein the computer-readable program code is further configured when executed by the processor to: transmitting a prompt to the first user; receiving a second code from first user; transmitting the second code to a user device associated with the second user.

Aspects of the above computer program product include wherein the first code is one of a text string, an image, and an audio clip.

Aspects of the above computer program product include wherein upon receiving the request for authorizing the first user, a timer is started, wherein if the timer reaches a predetermined amount of time prior to the first code being received, a new prompt is transmitted to the second user.

The phrases “at least one,” “one or more,” “or,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B and C together.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

Aspects of the present disclosure may take the form of an embodiment that is entirely hardware, an embodiment that is entirely software (including firmware, resident software, micro-code, etc.) or an embodiment combining software and hardware aspects that may all generally be referred to herein as a “circuit,” “module,” or “system.” Any combination of one or more computer-readable medium(s) may be utilized. The computer-readable medium may be a computer-readable signal medium or a computer-readable storage medium.

A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that can contain or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device. Program code embodied on a computer-readable medium may be transmitted using any appropriate medium, including, but not limited to, wireless, wireline, optical fiber cable, RF, etc., or any suitable combination of the foregoing.

The terms “determine,” “calculate,” “compute,” and variations thereof, as used herein, are used interchangeably and include any type of methodology, process, mathematical operation or technique.

What is claimed is:

1. A computer implemented method of authorizing a first user, the method comprising performing operations as follows on a processor of a computer system:
receiving a request for authorizing the first user;
transmitting a prompt to a second user;
receiving a first code from the second user;
transmitting the first code to a network location, wherein the network location is accessible by authorized users; and
enabling access for the second user to the network location.

2. The method of claim 1, further comprising receiving confirmation from the second user that the first user received the first code.

3. The method of claim 2, further comprising, upon receiving confirmation from the second user, activating a communication session between the first user and the second user.

4. The method of claim 1, further comprising:
transmitting a prompt to the first user;
receiving a second code from first user;
transmitting the second code to a user device associated with the second user.

5. The method of claim 1, wherein the first code is one of a text string, an image, and an audio clip.

6. The method of claim 1, wherein upon receiving the request for authorizing the first user, a timer is started, wherein if the timer reaches a predetermined amount of time prior to the first code being received, a new prompt is transmitted to the second user.

7. The method of claim 1, wherein transmitting the prompt comprising displaying a graphical user interface button in a user interface of an application executing on a user device associated with the second user.

8. A system, comprising:
a processor; and
a computer-readable storage medium storing computer-readable instructions which, when executed by the processor, cause the processor to:
receiving a request for authorizing the first user;
transmitting a prompt to a second user;
receiving a first code from the second user;
transmitting the first code to a network location, wherein the network location is accessible by authorized users; and
enabling access for the second user to the network location.

9. The system of claim 8, wherein the computer-readable instructions, when executed by the processor, further cause the processor to receiving confirmation from the second user that the first user received the first code.

10. The system of claim 9, wherein the computer-readable instructions, when executed by the processor, further cause the processor to, upon receiving confirmation from the second user, activating a communication session between the first user and the second user.

11. The system of claim 8, wherein the computer-readable instructions, when executed by the processor, further cause the processor to:
transmitting a prompt to the first user;
receiving a second code from first user;
transmitting the second code to a user device associated with the second user.

12. The system of claim 8, wherein the first code is one of a text string, an image, and an audio clip.

13. The system of claim 8, wherein upon receiving the request for authorizing the first user, a timer is started, wherein if the timer reaches a predetermined amount of time prior to the first code being received, a new prompt is transmitted to the second user.

14. The system of claim 8, wherein transmitting the prompt comprising displaying a graphical user interface button in a user interface of an application executing on a user device associated with the second user.

15. A computer program product, comprising:
a non-transitory computer-readable storage medium having computer-readable program code embodied therewith, the computer-readable program code configured when executed by a processor to:
receive a request for authorizing the first user;
transmit a prompt to a second user;
receive a first code from the second user;
transmit the first code to a network location, wherein the network location is accessible by authorized users; and
enable access for the second user to the network location.

16. The program product of claim 15, wherein the computer-readable program code is further configured to, when executed by the processor, receive confirmation from the second user that the first user received the first code.

17. The program product of claim 16, wherein the computer-readable program code is further configured to, when executed by the processor, upon receiving confirmation from the second user, activating a communication session between the first user and the second user.

18. The program product of claim 15, wherein the computer-readable program code is further configured when executed by the processor to:
transmitting a prompt to the first user;
receiving a second code from first user;
transmitting the second code to a user device associated with the second user.

19. The program product of claim 15, wherein the first code is one of a text string, an image, and an audio clip.

20. The program product of claim 15, wherein upon receiving the request for authorizing the first user, a timer is started, wherein if the timer reaches a predetermined amount of time prior to the first code being received, a new prompt is transmitted to the second user.
